(19) United States
(12) Patent Application Publication
(10) Pub. No.: US 2007/0126697 A1
(43) Pub. Date: Jun. 7, 2007

(54) Liquid crystal display device and display device

(75) Inventors: Hideo Sato, Hitachi (JP); Toshio Miyazawa, Chiba (JP)

Correspondence Address: Stanley P. Fisher;Reed Smith LLP, Suite 1400, 3110 Fairview Park Drive, Falls Church, VA, 22042-4503, US

(73) Assignee: Hitachi Displays, Ltd.

(21) Appl. No.: 11/596,000

(22) Filed: Nov. 13, 2006

(30) Foreign Application Priority Data
Dec. 1, 2005 (JP) 2005-347814
Sep. 7, 2006 (JP) 2006-242624

(51) Int. Cl. G09G 5/00

(52) U.S. Cl. 345/156

(57) ABSTRACT

In a liquid crystal display device which controls the brightness of a backlight by measuring an external light intensity around the liquid crystal display panel, it is possible to enhance the detecting accuracy even when the external light illuminance is low. A liquid crystal display device which includes a liquid crystal display panel, a backlight, a photo sensor, a photo sensor circuit which measures an external light illuminance around the liquid crystal display panel using the photo sensor and a control circuit which controls the backlight and the photo sensor circuit, wherein the control circuit periodically turns off the backlight and, at the same time, periodically outputs a control signal to start the measurement of the external light illuminance around the liquid crystal display panel to the photo sensor circuit, and the photo sensor circuit measures the external light illuminance around the liquid crystal display panel within an illuminance measuring period within a turn-off period of the backlight based on the control signal, and the control circuit changes the illuminance measuring period in response to the external light illuminance measured by the photo sensor circuit.

The present application claims priority from Japanese applications JP2005-347814 filed on Dec. 1, 2005 and JP2006-242624 filed on Sep. 7, 2006, the content of which is hereby incorporated by reference into this application.

### BACKGROUND OF THE INVENTION

The present invention relates to a liquid crystal display device and a display device, and more particularly to a liquid crystal display device which is capable of automatically controlling brightness of a backlight in response to brightness (the external light illuminance) around a liquid crystal display panel, and a display device having an illuminance detecting circuit.

In general, a liquid crystal display device is hardly used in a pitch dark state where there is no external light and is used in a state that a certain kind of external light, for example, a natural light or an indoor illumination light is radiated to a liquid crystal display panel. Accordingly, in following patent documents 1, 2, there has been disclosed a technique which measures the brightness (that is, the external light illuminance) around the liquid crystal display panel and controls the brightness of a backlight.

In the following patent document 1, when the surrounding is bright, to make the liquid crystal display panel more visible, the brightness of the backlight is increased, while when the surrounding is dark, a user can sufficiently observe the liquid crystal display panel even in dark and hence, the brightness of the backlight is decreased to suppress the power consumption.

Further, the following patent document 3 describes an illuminance-frequency conversing circuit which converts the illuminance measured by a photo sensor into frequency.

Here, as prior art documents related to the present invention, the following are known.

[Patent document 1]

JP-A-2003-21821

[Patent document 2]

JP-A-2002-72992

[Patent document 3]

JP-A-5-164609

### SUMMARY OF THE INVENTION

In the above-mentioned patent document 1, there is disclosed the technique which, for accurately detecting the external light illuminance, turns off the backlight to eliminate the influence of light from the backlight when the external light illuminance is detected. However, in the method described in the cited document 1, an external light illuminance detecting period is fixed thus giving rise to a possibility that the detection accuracy is lowered when the external light illuminance is low.

Further, according to the descriptions of the above-mentioned patent documents 1, 2, a photo sensor is provided at a position different from the liquid crystal display panel. This method requires the photo sensor as an individual part and hence, the method may hamper the miniaturization and the reduction of thickness of the liquid crystal display device.

In the above-mentioned patent document 3, there is a description that a Schmidt inverter is used in an illuminance-frequency converting circuit which converts the illuminance which is measured by the photo sensor into frequency. Since an illuminance-frequency conversion coefficient depends on two threshold voltages, that is, high and low voltages of the Schmidt inverter, when the sensor circuit is realized by a low-temperature poly-silicon thin film transistor (TFT), there exists a possibility that the frequency converting accuracy is lowered.

Further, the above-mentioned patent document 3 describes that an output frequency is inversely proportional to the capacitance (C). However, parasitic capacitances such as photo sensor capacitance and wiring capacitance are connected in parallel to the capacitance (C) and hence, there exists a possibility that the accuracy is lowered.

Further, the photo sensor which is realized by the low-temperature poly-silicon becomes large-sized and hence, the parasitic capacitance is also increased, and the output frequency depends on the parasitic capacitance, whereby there exists a possibility that the irregularities of the output frequency are increased.

The present invention has been made to overcome such drawbacks of the related art, and it is an object of the present invention to provide, in a liquid crystal display device which controls the brightness of a backlight by measuring the external light intensity around a liquid crystal display panel, a technique which can enhance the detection accuracy even when the external light illuminance is low.

It is another object of the present invention to provide a display device which includes an illuminance detecting circuit.

The above-mentioned and other objects of the present invention and novel features of the present invention will become apparent from the description of the present specification and attached drawings.

To briefly explain the summary of typical inventions among inventions disclosed in this specification, they are as follows.

(1) A liquid crystal display device which includes a liquid crystal display panel, a backlight, a photo sensor, a photo sensor circuit which measures an external light illuminance around the liquid crystal display panel using the photo sensor, and a control circuit which controls the backlight and the photo sensor circuit, wherein the control circuit periodically turns off the backlight and, at the same time, periodically outputs a control signal to start the measurement of the external light illuminance around the liquid crystal display panel to the photo sensor circuit, and controls the brightness of the backlight in response to the external light illuminance which is measured by the photo sensor circuit and is inputted from the photo sensor circuit, and the photo sensor circuit measures the external light illuminance around the liquid crystal display panel within an illuminance measuring period within a turn-off period of the backlight based on the control signal and outputs the measured external light illuminance to the control circuit, the improvement is characterized in that the control circuit changes the illuminance measuring period in response to the external light illuminance measured by the photo sensor circuit.

(2) In the above-mentioned constitution (1), the control circuit changes the illuminance measuring period and the turn-off period of the backlight in response to the external light illuminance measured by the photo sensor circuit.

(3) In the above-mentioned constitution (1) or (2), the control circuit shortens the illuminance measuring period when the external light illuminance measured by the photo sensor circuit is large and prolongs the illuminance measuring period when the external light illuminance measured by the photo sensor circuit is small.

(4) In the above-mentioned constitution (1) or (2), the control circuit shortens the turn-off period of the backlight when the external light illuminance measured by the photo sensor circuit is large and prolongs the turn-off period of the backlight when the external light illuminance measured by the photo sensor circuit is small.

(5) In the above-mentioned constitution (1) or (2), the control circuit prolongs a turn-on period of the backlight when the external light illuminance measured by the photo sensor circuit is large and shortens the turn-on period of the backlight when the external light illuminance measured by the photo sensor circuit is small.

(6) In any one of the above-mentioned constitutions (1) to (5), the photo sensor circuit outputs a pulse signal which differs in a pulse width of a first voltage level in response to the measured external light illuminance.

(7) In the above-mentioned constitution (6), the photo sensor circuit outputs a pulse signal having a short pulse width of the first voltage level when the measured external light illuminance is large and outputs a pulse signal having a long pulse width of the first voltage level when the measured external light illuminance is small.

(8) In the above-mentioned constitution (6) or (7), the control circuit shortens the illuminance measuring period when the pulse width of the first voltage level inputted from the photo sensor circuit is short and prolongs the illuminance measuring period when the pulse width of the first voltage level inputted from the photo sensor circuit is long.

(9) In the above-mentioned constitution (6) or (7), the control circuit shortens the turn-off period of the backlight when the pulse width of the first voltage level inputted from the photo sensor circuit is short and prolongs the turn-off period of the backlight when the pulse width of the first voltage level inputted from the photo sensor circuit is long.

(10) In the above-mentioned constitution (6) or (7), the control circuit prolongs the turn-on period of the backlight when the pulse width of the first voltage level inputted from the photo sensor circuit is short and shortens the turn-on period of the backlight when the pulse width of the first voltage level inputted from the photo sensor circuit is long.

(11) In the above-mentioned constitution (6) or (7), assuming Tp1, Tp2 (Tp1>Tp2) as first and second pulse widths of the first voltage level respectively and TB1, TB2, TB3 (TB1<TB2<TB3) as first to third turn-on periods of the backlight respectively, the control circuit sets the turn-on period TB of the backlight to TB1 (TB=TB1) when the pulse width Tp of the first voltage level inputted from the photo sensor circuit is Tp>Tp1, sets the turn-on period TB of the backlight to TB2 (TB=TB2) when the pulse width Tp of the first voltage level inputted from the photo sensor circuit is Tp1≧Tp>Tp2, and sets the turn-on period TB of the backlight to TB3 (TB=TB3) when the pulse width Tp of the first voltage level inputted from the photo sensor circuit is Tp2≧Tp.

(12) In the above-mentioned constitution (6) or (7), assuming Tp1, Tp2 (Tp1>Tp2) as first and second pulse widths of the first voltage level respectively and TB1, TB2, TB3 (TB1<TB2<TB3) as first to third turn-on periods of the backlight respectively, the control circuit sets the turn-on period TB of the backlight to TB1 (TB=TB1) when the turn-on period of the backlight at a point of time that the external light illuminance is measured is TB1, and the pulse width Tp of the first voltage level inputted from the photo sensor circuit is Tp>Tp1,

sets the turn-on period TB of the backlight to TB2 (TB=TB2) when the turn-on period of the backlight at a point of time that the external light illuminance is measured is TB1, and the pulse width Tp of the first voltage level inputted from the photo sensor circuit is Tp<Tp1,

sets the turn-on period TB of the backlight to TB1 (TB=TB1) when the turn-on period of the backlight at a point of time that the external light illuminance is measured is TB2, and the pulse width Tp of the first voltage level inputted from the photo sensor circuit is Tp>Tp1,

sets the turn-on period TB of the backlight to TB2 (TB=TB2) when the turn-on period of the backlight at a point of time that the external light illuminance is measured is TB2, and the pulse width Tp of the first voltage level inputted from the photo sensor circuit is Tp1≧Tp>Tp2,

sets the turn-on period TB of the backlight to TB3 (TB=TB3) when the turn-on period of the backlight at a point of time that the external light illuminance is measured is TB2, and the pulse width Tp of the first voltage level inputted from the photo sensor circuit is Tp2>Tp,

sets the turn-on period TB of the backlight to TB3 (TB=TB3) when the turn-on period of the backlight at a point of time that the external light illuminance is measured is TB3, and the pulse width Tp of the first voltage level inputted from the photo sensor circuit is Tp2>Tp, and

sets the turn-on period TB of the backlight to TB2 (TB=TB2) when the turn-on period of the backlight at a point of time that the external light illuminance is measured is TB3, and the pulse width Tp of the first voltage level inputted from the photo sensor circuit is Tp≧Tp2.

(13) In any one of the above-mentioned constitutions (1) to (12), the control circuit controls the brightness of the backlight in response to the pulse width of the pulse signal of the first voltage level inputted from the photo sensor circuit.

(14) In any one of the above-mentioned constitutions (1) to (13), the liquid crystal display device includes a dark current correcting transistor which corrects a dark current of the photo sensor.

(15) In any one of the above-mentioned constitutions (1) to (14), the liquid crystal display device includes a plurality of photo sensors and changes over the illuminance detection sensitivity by selecting a predetermined number of photo sensors out of the plurality of photo sensors when the external light illuminance is measured.

(16) In any one of the above-mentioned constitutions (1) to (15), the liquid crystal display panel includes a plurality of pixels each of which includes a thin film transistor, and the photo sensor and the photo sensor circuit are formed on the same substrate on which the thin film transistors of the respective pixels are formed.

(17) In any one of the above-mentioned constitutions (1) to (16), the photo sensor is arranged at a dummy pixel portion which is a periphery of a display part of the liquid crystal display panel.

(18) In any one of the above-mentioned constitutions (1) to (17), the control circuit is a circuit which is formed in a semiconductor chip.

(19) In a display device having an illuminance detecting circuit, the illuminance detecting circuit includes a photo sensor which changes a photocurrent in response to an external light illuminance, a capacitance from which a charge is discharged in response to flowing of the photocurrent to the photo sensor, an inverting circuit which is operated in response to inputting of a voltage of the capacitance, and a switch of which an output is connected to one end of the capacitance and charges the capacitance corresponding to an output signal level of the inverting circuit, wherein a voltage level of another end of the capacitance is changed corresponding to an output signal level of the inverting circuit.

(20) In the constitution (19), when the output signal level of the inverting circuit is high, the switch is turned on and, at the same time, the voltage level of another end of the capacitance is set to a first voltage, while when the output signal level of the inverting circuit is low, the switch is turned off and, at the same time, the voltage level of another end of the capacitance is set to a second voltage.

(21) In the constitution (20), the first voltage is lower than the second voltage.

(22) In any one of the constitutions (19) to (21), the second voltage is a reference voltage.

(23) In any one of the constitutions (19) to (22), the second capacitance is connected to an input of the inverting circuit.

(24) In a display device having an illuminance detecting circuit, the illuminance detecting circuit includes a photo sensor which changes a photocurrent in response to an external light illuminance, a capacitance from which a charge is discharged in response to flowing of the photocurrent to the photo sensor, and a first transistor which outputs a clock inputted to a first terminal when a voltage of the capacitance becomes a predetermined voltage or more.

(25) In the constitution (24), the first terminal is a source-electrode-side terminal of the first transistor, the output is outputted from a drain electrode of the first transistor, and the capacitance is connected between a gate electrode and the drain electrode of the first transistor.

(26) In the constitution (24) or (25), the display device includes a second transistor which has the output connected to a ground potential in response to a second clock which differs from the clock.

(27) In any one of the constitutions (19) to (26), the display device includes a dark current correction transistor which corrects a dark current of the photo sensor.

(28) In any one of the constitutions (19) to (27), the display device includes a second transistor which is connected to the photo sensor in a cascade connection, and a charge of the capacitance is discharged by the photo sensor via the second transistor.

(29) In any one of the constitutions (19) to (28), the illuminance detecting circuit is integrally formed on a substrate on which pixels or a peripheral circuit which constitute the display device are formed.

To briefly explain advantageous effects obtained by typical inventions among the inventions disclosed in this specification, they are as follows.

According to the present invention, in the liquid crystal display device which controls the brightness of the backlight by measuring the external light intensity around the liquid crystal display panel, it is possible to enhance the detecting accuracy even when the external light illuminance is low.

Further, according to the present invention, in the display device which includes the illuminance detecting circuit, it is possible to enhance the detection accuracy even when the external light illuminance is low.

### BRIEF DESCRIPTION OF DRAWINGS

FIG. 1 is a block diagram showing the schematic constitution of a liquid crystal display device according to an embodiment 1 of the present invention;

FIG. 2 is a view showing the cross-sectional structure of one example of a photo sensor shown in FIG. 1;

FIG. 3 is a view showing the cross-sectional structure of another example of the photo sensor shown in FIG. 1;

FIG. 4 is a view showing a timing chart for an input/output signal of the photo sensor circuit and a control signal of a backlight shown in FIG. 1;

FIG. 5 is a view showing one example of the backlight shown in FIG. 1;

FIG. 6A is a circuit diagram showing the circuit constitution of one example of the photo sensor circuit shown in FIG. 1;

FIG. 6B is a circuit diagram showing the circuit constitution of another example of the photo sensor circuit shown in FIG. 1;

FIG. 6C is a circuit diagram showing the circuit constitution of another embodiment of the photo sensor circuit shown in FIG. 1;

FIG. 6D is a view showing the cross-sectional structure of the photo sensor circuit shown in FIG. 6C;

FIG. 6E is a circuit diagram showing the circuit constitution of another embodiment of the photo sensor circuit shown in FIG. 1;

FIG. 6F is a circuit diagram showing the circuit constitution of a modification of the photo sensor circuit shown in FIG. 6E;

FIG. 7 is a view showing a timing chart of the photo sensor circuit shown in FIG. 6A;

FIG. 8 is a view showing a flowchart of one example of a backlight control according to the embodiment 1 of the present invention;

FIG. 9 is a view showing one example of an operation timing at the time of changing an output pulse width Tp of the photo sensor circuit according to an embodiment 1 of the present invention;

FIG. 10 is a graph showing the relationship between an output pulse width Tp of the photo sensor circuit shown in FIG. 1 and an external light illuminance E;

FIG. 11 is a graph showing the relationship between an external light illuminance E obtained from a flowchart shown in FIG. 8 and a backlight ON period TB;

FIG. 12 is a view showing a flowchart of another embodiment of the backlight control according to the embodiment 1 of the present invention;

FIG. 13 is a circuit diagram showing the circuit constitution of another embodiment of the photo sensor circuit shown in FIG. 1;

FIG. 14 is a view showing a timing chart of the photo sensor circuit shown in FIG. 13;

FIG. 15 is a circuit diagram showing the circuit constitution of another embodiment of the photo sensor circuit shown in FIG. 1;

FIG. 16 is a view showing a timing chart of the photo sensor circuit shown in FIG. 15;

FIG. 17A is a circuit diagram showing the circuit constitution of another embodiment of the photo sensor circuit shown in FIG. 1;

FIG. 17B is a circuit diagram showing the circuit constitution of one example of the photo sensor circuit shown in FIG. 1;

FIG. 17C is a view showing a timing chart of the photo sensor circuit shown in FIG. 17B;

FIG. 17D is a circuit diagram showing the circuit constitution of another embodiment of the photo sensor circuit shown in FIG. 1;

FIG. 18 is a circuit diagram showing the circuit constitution of another embodiment of the photo sensor circuit shown in FIG. 1;

FIG. 19 is a block diagram showing the schematic constitution of a liquid crystal display device according to an embodiment 2 of the present invention; and

FIG. 20 is a block diagram showing the schematic constitution of a liquid crystal display device according to an embodiment 3 of the present invention.

### DESCRIPTION OF THE PREFERRED EMBODIMENTS

Embodiments of the present invention are explained hereinafter in detail in conjunction with drawings.

Here, in all drawings for explaining the embodiments, parts having identical functions are given same symbols, and their repeated explanation is omitted.

### Embodiment 1

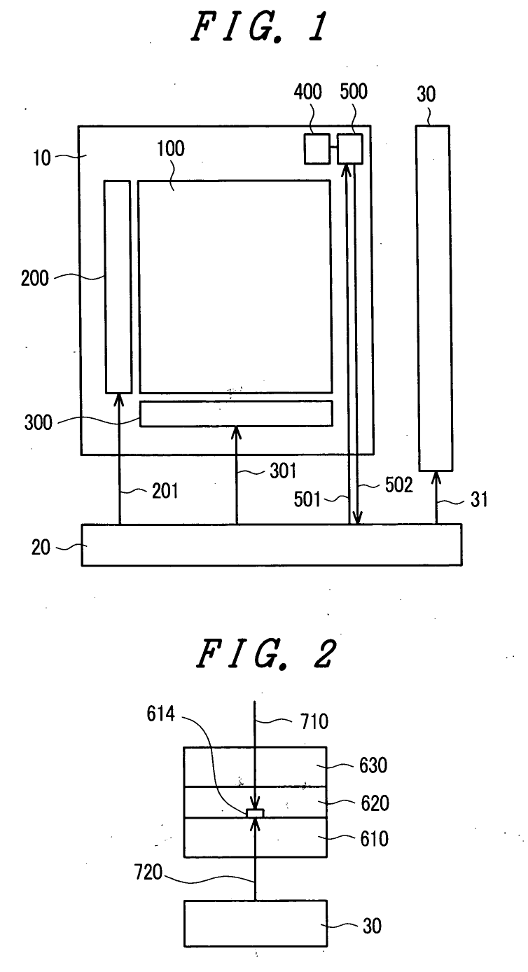

FIG. 1 is a block diagram showing the schematic constitution of a liquid crystal display device according to an embodiment 1 of the present invention.

The liquid crystal display device of this embodiment is constituted of a liquid crystal display panel 10, a control circuit 20 and a backlight 30.

The liquid crystal display panel 10 includes a display part 100, a gate circuit 200, a drain circuit 300, a photo sensor 400 and a photo sensor circuit 500.

The control circuit 20 outputs a control signal 201 to the gate circuit 200, outputs a control signal 301 to the drain circuit 300 and outputs an input signal 501 to the photo sensor circuit 500. Further, the control circuit 20 outputs a control signal 31 to the backlight 30. Further, an output signal 502 is inputted into the control circuit 20 from the photo sensor circuit 500.

FIG. 2 is a view showing the cross-sectional structure of one example of the photo sensor 400 shown in FIG. 1.

The liquid crystal display panel includes a TFT substrate 610 on which thin film transistors, pixel electrode and the like are formed, a CF substrate (counter substrate) 630 on which color filters and the like are formed, and liquid crystal 620 which is sandwiched between the TFT substrate 610 and the CF substrate 630.

A photo sensor 614 is arranged on the TFT substrate 610, while the backlight 30 is arranged below the TFT substrate 610.

An external light 710 is incident on the photo sensor 614 from the direction of the CF substrate 630, and a backlight light 720 is incident on the photo sensor 614 from the direction of the TFT substrate 610.

The photo sensor 614 is a photo diode having the diode connection structure of a thin film transistor, that is, a parasitic photo diode or a photo diode having the PIN structure.

The photo sensor 614 having the structure described above can accurately detect the illuminance of the external light 710 without being influenced by the backlight light 720 by driving the photo sensor circuit 500 and the backlight 30 at timings in a timing chart shown in FIG. 4.

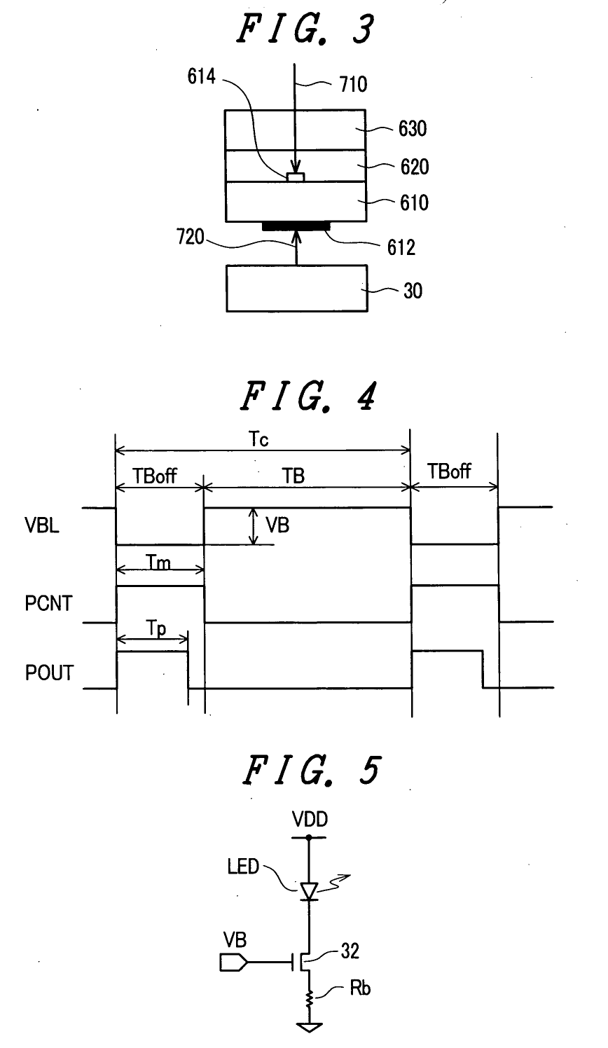

FIG. 3 is a view showing the cross-sectional structure of another embodiment of the photo sensor 400 shown in FIG. 1.

The constitution which makes the cross-sectional structure of this embodiment different from the cross-sectional structure shown in FIG. 2 lies in that a light blocking film 612 is added to the TFT substrate 610. Due to such a constitution, the photo sensor 614 can accurately detect the illuminance of the external light 710 without being influenced by the backlight light 720. Accordingly, the photo sensor 614 having the constitution shown in FIG. 3 is also applicable to a method for controlling the brightness of the backlight 30 based on voltage amplitude besides the method for driving the photosensor circuit 500 and the backlight 30 at timings in the timing chart shown in FIG. 4.

Here, in this embodiment, the control circuit 20 is formed on a set substrate of a liquid crystal panel applicable product, and the drain circuit 300 is formed in the inside of the semiconductor chip which is COG (Chip on Glass)-mounted on a TFT substrate, and a gate circuit 200, a photo sensor 400 and a photo sensor circuit 500 are formed (integrally formed) on the same substrate on which thin film transistors of respective pixels in the display part 100 are formed.

FIG. 4 is a view showing input/output signals of the photo sensor circuit 500 and also is a timing chart of control signals of the backlight 30 shown in FIG. 1.

In FIG. 4, a signal VBL is a control signal 31 of the backlight 30, a signal PCNT is an input signal 501 of the photo sensor circuit 500, and a signal POUT is an output signal 502 of the photo sensor circuit 500.

A signal VBL is a signal having a cycle TC, an OFF period TBoff, an ON period TB and a voltage VB in the ON period TBoff.

The signal PCNT is a signal which indicates an illuminance detecting period Tm of the photo sensor circuit 500, and the illuminance detecting period Tm is less than the OFF period TBoff.

The signal POUT is an output signal of the photo sensor circuit 500, and a period Tp is inversely proportional to the illuminance as explained later in conjunction with FIG. 8.

FIG. 5 is a view showing one example of the backlight 30 shown in FIG. 1.

The backlight 30 is constituted of a light-emitting diode (LED), a transistor 32 and a resister (Rb), and the light-emitting diode (LED) is controlled by switching based on a VB voltage which is applied to a terminal of the diode (LED).

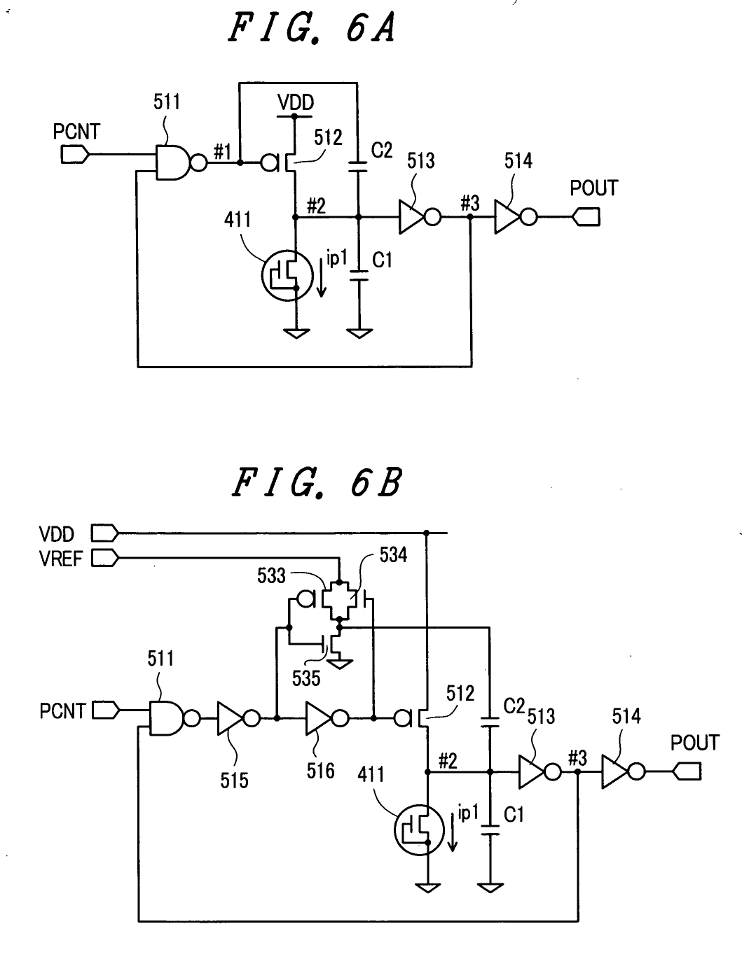

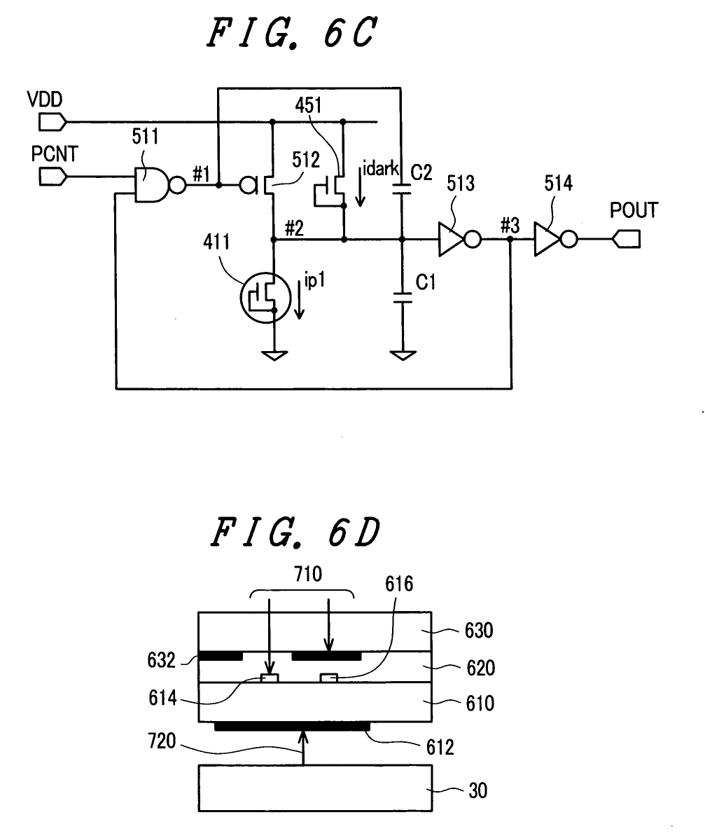

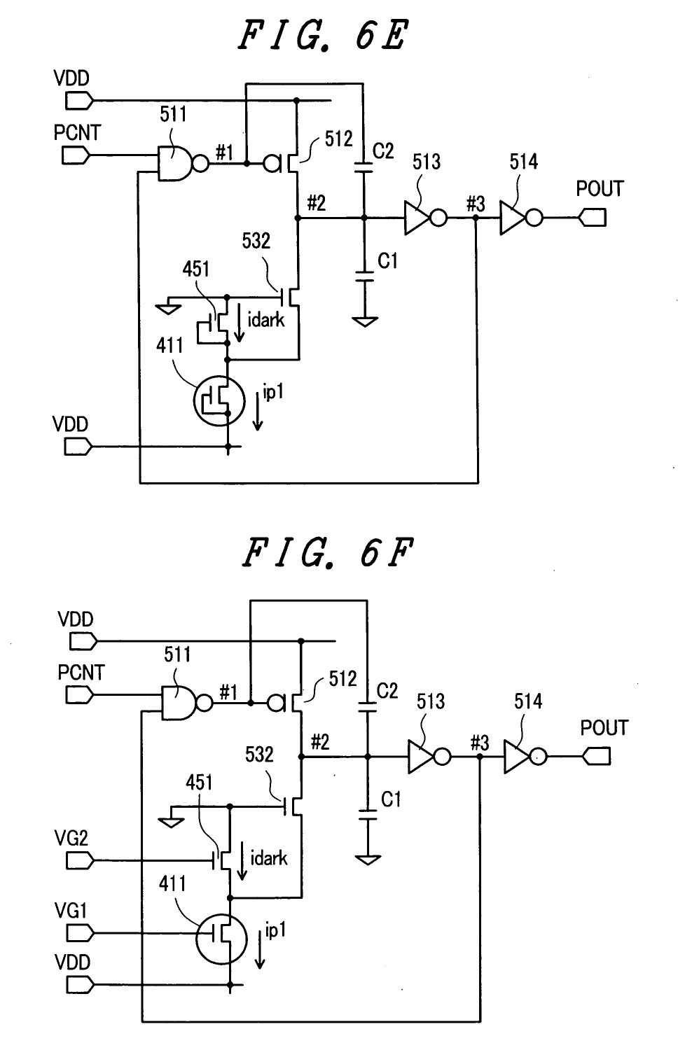

FIG. 6A is a circuit diagram showing the circuit constitution of one example of the photo sensor circuit 500 shown in FIG. 1.

The photo sensor circuit 500 shown in FIG. 6A is constituted of a photo sensor 411, capacitances (C1, C2), a P-type MOS (hereinafter referred to as a PMOS) transistor 512, a NAND gate 511 and inverters (513, 514).

A photo sensor circuit shown in FIG. 6A is constituted of a negative-feedback loop which includes the NAND gate 511, the PMOS transistor 512 and the inverter 513, and a positive-feedback loop which includes the NAND gate 511, the capacitance (C2) and the inverter 513.

The photo sensor 411 is a parasitic photo diode of a thin film transistor, and a photo-electric current (ip1) flows in the photo sensor 411 in response to an external light illuminance between a source and a drain of the thin film transistor.

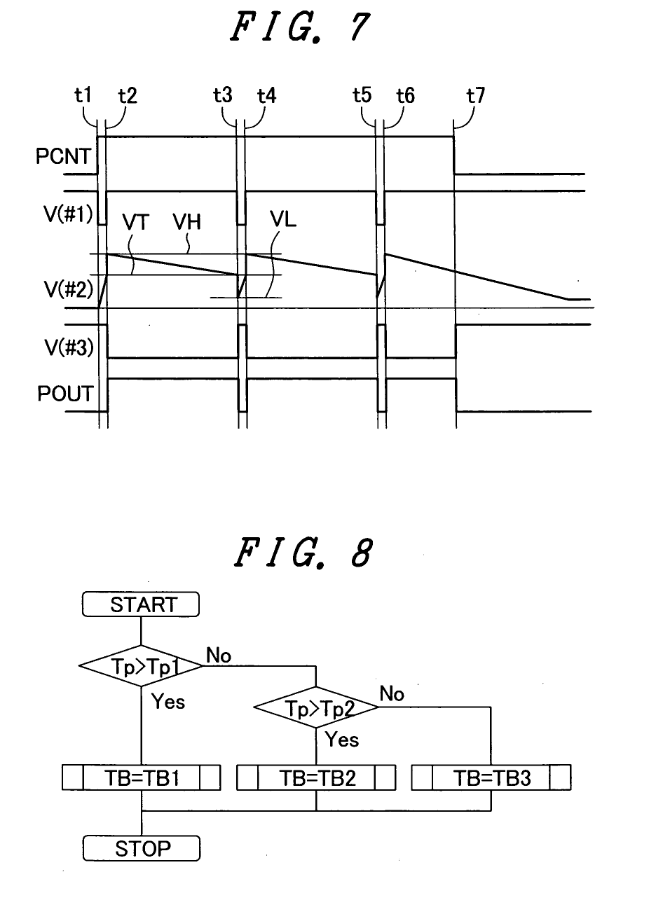

FIG. 7 is a timing chart showing timing of the photo sensor circuit shown in FIG. 6A.

In addition to the input signal (PCNT) and the output signal (POUT), voltages V(#1), V(#2) and V(#3) of inner nodes #1, #2 and #3 are shown in FIG. 7.

When the input signal (PCNT) assumes “Low level (hereinafter, referred to as L)”, the node #1 assumes “High level (hereinafter, referred to as H)”, the node #2 assumes GND, the node #3 assumes “H”, and the output signal (POUT) assumes “L”.

When the input signal (PCNT) assumes “H” at a point of time t1, the node #1 assumes “L” whereby the PMOS transistor 512 assumes an ON state. Accordingly, when the input signal (PCNT) exceeds the point of time t1, the voltage V(#2) of the node #2 is sharply increased due to the ON resistance of the PMOS transistor 512.

When the voltage V(#2) of the node #2 exceeds a threshold voltage (VT) of the inverter 513 at a point of time t2, the node #3 assumes “L”, and the node #1 assumes “H” whereby the PMOS transistor 512 assumes an OFF state.

Here, the voltage V(#2) of the node #2 is increased to the voltage of VH in a step-like manner due to the H level of the node #1 and the capacitance (C2). Thereafter, charges of the capacitances (C1, C2) are discharged in response to a current (ip1) of the photo sensor 411 and hence, the voltage V(#2) is decreased.

When the voltage V(#2) of the node #2 becomes lower than the threshold voltage VT of the inverter 513 at a point of time t3, the node #3 assumes “H”, and the node #1 assumes “L” whereby the PMOS transistor 512 assumes an ON state. At this point of time, the voltage V(#2) of the node #2 is lowered to the voltage of VL in a step-like manner in response to the L level voltage of the node #1 and the capacitance (C2). Thereafter, the voltage V(#2) is sharply increased due to the ON resistance of the PMOS transistor 512.

Thereafter, an output corresponding to the photocurrent (ip1) of the photo sensor 411 can be obtained by repeating the operations at the points of time t2 to t4.

In such an operation, a maximum voltage VH and a minimum voltage VL of the voltage V(#2) of the node #2 are expressed by following formulae (1) and (2).
VH=VT+C2/(C1+C2)×VDD (1)
VL=VT−C2/(C1+C2)×VDD (2)

Further, a time t23 from the point of time t2 and the point of time t3 and a time t34 from the point of time t3 and the point of time t4 are expressed by following formulae (3) and (4) in response to an ON current (ion) of the PMOS transistor and an photocurrent (ip1) of the photo sensor 411.

$$\begin{matrix}\begin{matrix}t 23 = ( C 1 + C 2 ) \times ( VH - VT ) / ip 1 \\ = C 2 \times VDD / ip 1\end{matrix} & ( 3 ) \\ \begin{matrix}T 34 = ( C 1 + C 2 ) \times ( VT - VL ) / ip 1 \\ = C 2 \times VDD / ion\end{matrix} & ( 4 )\end{matrix}$$

As shown in the above-mentioned formula (3), the time t23 is inversely proportional to the photocurrent (ip1). Here, by selecting the relationship ion>>ip1, a frequency (fout) of the output signal (POUT) is, as shown in the following formula (5), directly proportional to the photocurrent (ip1).
fout=ip1/(C2×VDD) (5)

As can be understood from the above-mentioned formula (5), it is possible to detect the photocurrent (ip1) based on the frequency (fout) of the output signal (POUT). Further, the frequency (fout) does not depend on the capacitance (C1) and hence, the frequency (fout) is not influenced by the parasitic capacitance which is connected to the node #2.

Further, from the formulae (1) and (2), it is understood that the maximum voltage (VH) and the minimum voltage (VL) of the voltage V(#2) of the node #2 are controlled based on the capacitance (C1). Due to the capacitance (C1), the voltage V(#2) of the node #2 is set to 0≦V(#2)≦VDD.

This is because that when the voltage V(#2) of the node #2 assumes VDD or more or GND or less, the PMOS transistor 512 or the photo sensor 411 assumes an ON state and hence, the voltage of VH or VL differs from the voltage in the formulae (1) or (2) thus giving rise to an error in the output frequency (fout)

As has been explained heretofore, the photo sensor circuit 500 shown in FIG. 6A includes the photo sensor 411 in which the photocurrent (ip1) is changed in response to the external light illuminance, the capacitance (C2) from which the charge is discharged in response to the flowing of the photocurrent (ip1) to the photo sensor 411, an inverting circuit 513 which is operated in response to inputting of a voltage of the capacitance (C2), and a switch 512 where an output is connected to one end of the capacitance (C2) and charges the capacitance (C2) corresponding to an output signal level of the inverting circuit 513, wherein a voltage level of another end of the capacitance (C2) is changed corresponding to an output signal level of the inverting circuit 513. Here, when the output signal level of the inverter circuit 513 is high, the photo sensor circuit 500 turns on the switch 512 and, at the same time, the voltage level of another end of the condenser (C2) is set to a first voltage while when the output signal level of the inverter circuit 513 is low, the photo sensor circuit 500 turns off the switch 512 and, at the same time, the voltage level of another end of the condenser (C2) is set to a second voltage. Here, the first voltage is lower than the second voltage.

FIG. 6B is a circuit diagram showing the circuit constitution of another embodiment of the photo sensor circuit 500 shown in FIG. 1.

The constitution which makes the photo sensor circuit 500 of this embodiment different from the photo sensor circuit 500 shown in FIG. 6A lies in that a PMOS transistor 533, N-type MOS (hereinafter, referred to as NMOS) transistors (534, 535), inverters (515, 516) are added to the photo sensor circuit 500, and the capacitance (C2) is driven based on a reference voltage (VREF).

The output frequency (fout) of the photo sensor circuit 500 shown in FIG. 6B is, as shown in the following formula (6), inversely proportional to the reference voltage (VREF).
fout=ip1/(C2×VREF) (6)

In this manner, in the photo sensor circuit 500 shown in FIG. 6B, the output frequency (fout) can be controlled based on the reference voltage (VREF) and hence, it is possible to adjust irregularities in characteristics of the sensor based on the reference voltage (VREF).

FIG. 6C is a circuit diagram showing the circuit constitution of another embodiment of the photo sensor circuit 500 shown in FIG. 1.

The constitution which makes the photo sensor circuit 500 of this embodiment different from the photo sensor circuit 500 shown in FIG. 6A lies in that a thin film transistor 451 for correcting a dark current is added, and a dark current of the photo sensor 411 is corrected.

FIG. 6D is the cross-sectional structure of the photo sensor circuit 500 shown in FIG. 6C. The constitution which makes the photo sensor circuit 500 of this embodiment different from the photo sensor circuit 500 shown in FIG. 3 lies in that a thin film transistor 616 for correcting dark current and a light blocking film 632 of the CF substrate 610 is added to the photo sensor circuit 500. A thin film transistor 616 for correcting a dark current is arranged below the light blocking film 631 formed on the CF substrate 610.

The photo sensor 614 is a photo diode having the diode connection structure of a thin film transistor, that is, a parasitic photo diode or a photo diode having the PIN structure. The thin film transistor 616 for correcting a dark current is, in the same manner as the photo sensor 614, a photo diode having the diode connection structure of a thin film transistor, that is, a parasitic photo diode or a photo diode having the PIN structure.

An output frequency (fout) of the photo sensor circuit 500 shown in FIG. 6C is, as shown in the following formula (7), directly proportional to the difference between the photocurrent (ip1) and the dark current (idark).
fout=(ip1−idark)/(C2×VDD) (7)

The thin film transistor 616 for correcting a dark current adopts the same structure as the photo sensor 614 and hence, the dark current of the thin film transistor for correcting a dark current is substantially equal to the dark current of the photo sensor 614. As a result, since the dark current of the photo sensor can be corrected using the formula (7), it is possible to detect the illuminance with higher accuracy.

FIG. 6E is a circuit diagram showing the circuit constitution of another embodiment of the photo sensor circuit 500 shown in FIG. 1.

The constitution which makes the photo sensor circuit 500 of this embodiment different from the circuit constitution of the photo sensor circuit 500 shown in FIG. 6C lies in the arrangements of the photo sensor 411 and the thin film transistor 451 for correcting a dark current.

In this embodiment, the photo sensor 411 and the dark current correcting transistor 451 are arranged between the ground potential (GND) and the negative power source (VSS), and the photocurrent (ip1) of the photo sensor 411 is taken out through the NMOS transistor 532 which has a gate thereof grounded.

A source potential of the NMOS transistor 532 having the gate thereof grounded is fixed to a potential of (GND-Vth) and hence, as a result, a voltage applied to the photo sensor 411 is fluctuated in the photo sensor circuit 500 shown in FIG. 6C at the same degree as the fluctuation of the voltage of the photo sensor circuit 500 shown in FIG. 6A while, in the photo sensor circuit 500 shown in FIG. 6E, the voltage is substantially stable. Accordingly, it is possible to detect the illuminance with higher accuracy in the photo sensor circuit 500 shown in FIG. 6E. Here, symbol Vth indicates a threshold voltage of the NMOS transistor 532.

FIG. 6F is a circuit diagram showing the circuit constitution of a modification of the photo sensor circuit 500 shown in FIG. 6E.

The constitution which makes the photo sensor circuit 500 of this embodiment different from the circuit constitution of the photo sensor circuit 500 shown in FIG. 6E lies in that voltages of (VG1, VG2) are applied to the respective gate terminals of the photo sensor 411 and the thin film transistor 451 for correcting a dark current. The dark current of the thin film transistor connected in diode connection is changed corresponding to the threshold voltages. However, in the photo sensor circuit 500 shown in FIG. 6F, the voltages of (VG1, VG2) are set such that the voltage between the gate source of the photo sensor 411 and the gate source of the thin film transistor 451 for correcting dark current assumes a negative value. As a result, the dark current is decreased and, at the same time, the fluctuation of the dark current attributed to the threshold voltage is also decreased and hence, it is possible to detect the illuminance with higher accuracy.

A flowchart of one example of a backlight control according to the embodiment is shown in FIG. 8.

Tp shown in FIG. 8 is an output pulse width of the photo sensor circuit 500 and is a time t23 from a point of time t2 to a point of time t3 in a timing chart shown in FIG. 7. The flowchart shown in FIG. 8 is a flowchart in which a turn-on period TB of the backlight is set based on a value of the Tp.

In this example, under three conditions of setting Tp as Tp>Tp1, Tp1>Tp>Tp2 and Tp≦Tp2 respectively, the turn-on periods TB of the backlight are set to TB1, TB2 and TB3.

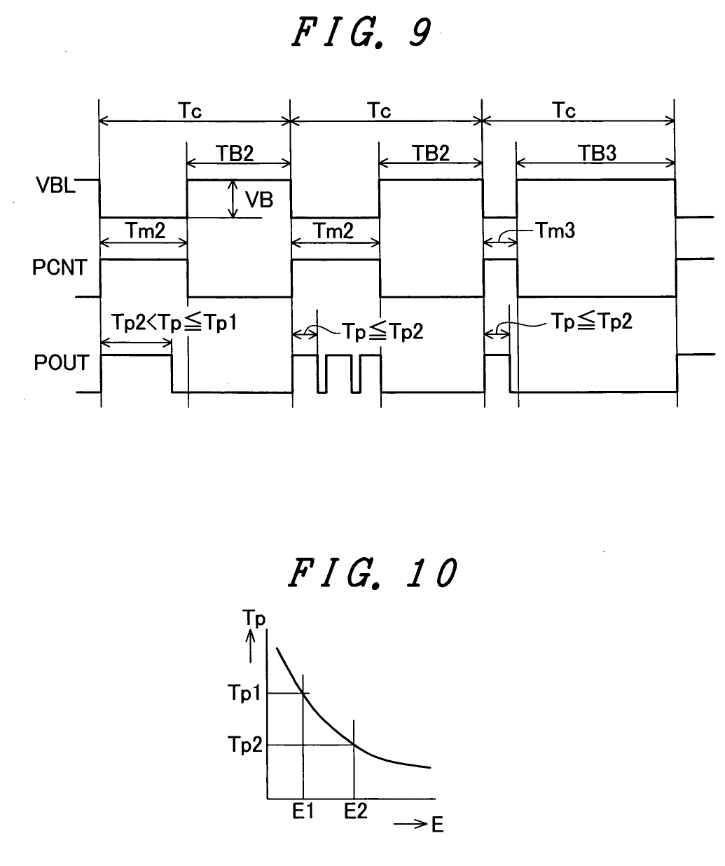

In FIG. 9, one example of the operation timing when the output pulse width Tp of the photo sensor circuit 500 is changed from Tp1≧Tp>Tp2 to Tp≦Tp2 is shown.

Under the condition that the output pulse width Tp is Tp1≧Tp>Tp2, the turn-on period TB of the backlight is set to TB2, and the illuminance detecting period Tm is set to Tm2.

When the output pulse width Tp is changed to Tp≦Tp2 with the operation at this timing, the illuminance detecting period Tm is changed to Tm3, and the turn-on period TB of the backlight is changed to TB3.

In this manner, the backlight ON period TB and the illuminance detecting period Tm are changed in response to the value of the output pulse width Tp.

The relationship between the output pulse width Tp of the photo sensor circuit 500 shown in FIG. 1 and an external light illuminance E is shown in FIG. 10.

The output pulse width Tp is, as shown in the above-mentioned formula (3), inversely proportional to the illuminance E. The output pulse widths of the photo sensor circuit 500 corresponding to the illuminances (E1, E2) are set as Tp1, Tp2.

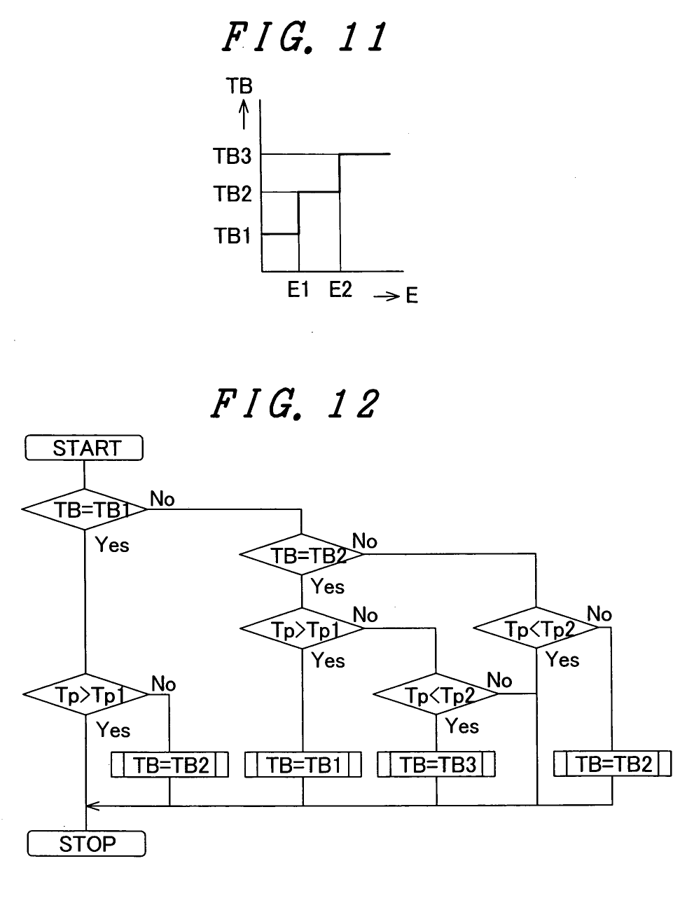

The relationship between the external light illuminance E which is obtained using the flowchart shown in FIG. 8 and the turn-on period TB of the backlight is shown in FIG. 11.

Under respective conditions in which the external light illuminances E is assumed as E<E1, E1≦E<E2 and E≧E2 respectively, the turn-on periods TB of the backlight assumes values of TB1, TB2 and TB3, respectively.

The backlight becomes brighter along with the increase of the turn-on period TB of the backlight. Accordingly, in the flowchart shown in FIG. 8, by controlling the backlight, it is possible to decrease the brightness of the backlight in a place where the external light illuminance is low and dark, while it is possible to increase the brightness of the backlight in a bright place and hence, it is possible to realize a display which is easy to observe even when the external light illuminance is changed.

A flowchart of another example of the backlight control according to this embodiment is shown in FIG. 12. The flowchart shown in FIG. 12 shows a method in which the determination of the output pulse width Tp and the setting of the turn-on period TB of the backlight are performed with respect to every condition of the turn-on period TB of the backlight.

That is, in the flowchart shown in FIG. 12, the turn-on period TB of the backlight is controlled in a following manner.
(1) When TB=TB1, Tp and Tp1 are compared, and TB is set to TB1 or TB2.
(2) When TB=TB2, comparison between Tp and Tp1, Tp2 is performed, and TB is set to TB2 or TB1, TB3.
(3) When TB=TB3, Tp and Tp2 is compared, and TB is set to TB3 or TB2.

A turn-off period TBoff of the backlight is the difference between the cycle Tc of the control signal of the backlight and the turn-on period TB of the backlight and hence, the TBoff is long when TB=TB1, and the TBoff is short when TB=TB3.

Due to this control method, when the turn-off period TBoff of the backlight is long, it is possible to compare the long output pulse width Tp1, while when the turn-off period TBoff of the backlight is short, it is possible to compare the short output pulse width Tp2 and hence, it is possible to set the long turn-on period TB of the backlight.

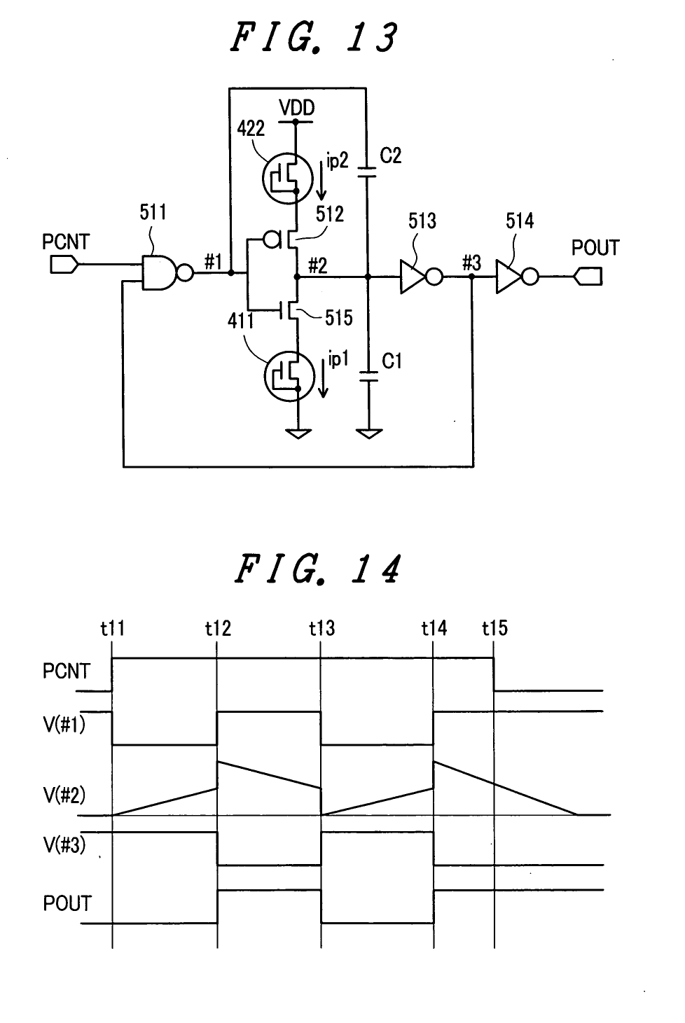

FIG. 13 is a circuit diagram showing the circuit constitution of another embodiment of the photo sensor circuit 500 shown in FIG. 1. The constitution which makes the photo sensor circuit 500 of this embodiment different from the circuit constitution of the photo sensor circuit 500 shown in FIG. 6A lies in that two photo sensors (421, 422), an NMOS transistor 520, a PMOS transistor 512 are used in the circuit constitution.

A timing chart of the photo sensor circuit shown in FIG. 13 is shown in FIG. 14.

When the voltage V(#1) of the node #1 assumes “L”, the PMOS transistor 512 is turned on, and the NMOS transistor 520 is turned off and hence, the capacitances (C1, C2) are charged in response to the photocurrent (ip2) of the photo sensor 422, and the voltage (V#2) of the node #2 is increased.

On the other hand, when the voltage V(#1) of the node #1 assumes “H”, the PMOS transistor 512 is turned off, and the NMOS transistor 520 is turned on and hence, the capacitances (C1, C2) are discharged in response the photocurrent (ip1) of the photo sensor 421, and the voltage (V#2) of the node #2 is decreased.

In the example shown in FIG. 13, the times (tL, tH) in which Vs (#1) of the node #1 are “L” and “H” are respectively inversely proportional to the photo currents (ip2, ip1) and hence, the times (tL, tH) are expressed by following formulae (8), (9).

$$\begin{matrix}\begin{matrix}tL = t 12 - t 11 \\ = C 2 \times VDD / ip 2\end{matrix} & ( 8 ) \\ \begin{matrix}tH = t 13 - t 12 \\ = C 2 \times VDD / ip 1\end{matrix} & ( 9 )\end{matrix}$$

Accordingly, the output frequency fout of the example shown in FIG. 13 is expressed by a following formula (10).
fout=ip1×ip2/(ip1+ip2)/(C2×VDD) (10)

In the example shown in FIG. 13, both of the periods in which the outputs are “H” and “L” have relationships in which both of the periods are inversely proportional to the photocurrent and hence, it is possible to detect the illuminance using the frequency fout of the output signal POUT thereof with high accuracy.

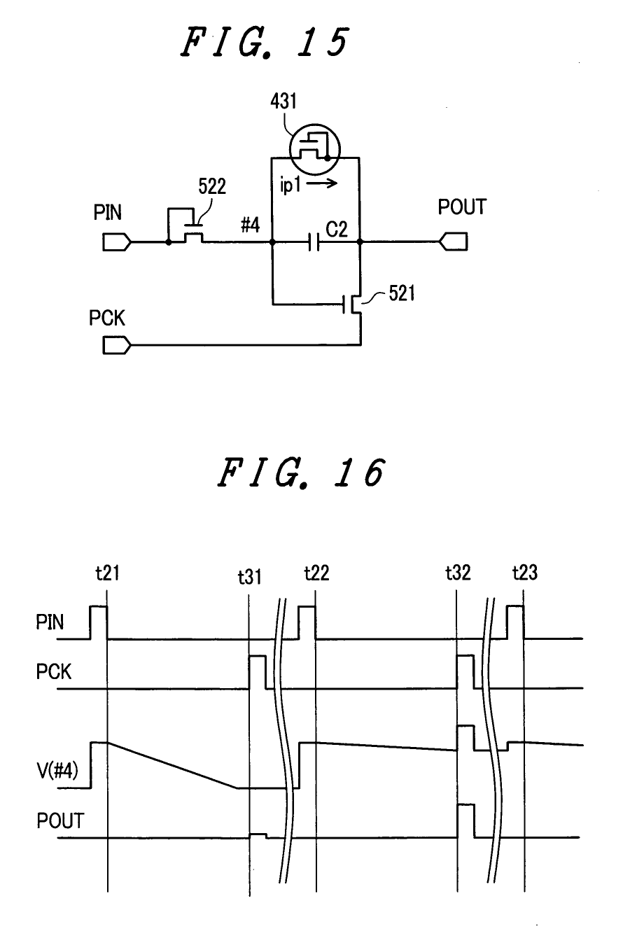

FIG. 15 is a circuit diagram showing the circuit constitution of another embodiment of the photo sensor circuit 500 shown in FIG. 1.

The example shown in FIG. 15 is constituted of an NMOS single channel circuit, wherein the NMOS single channel circuit is constituted of a photo sensor 431, NMOS transistors (521, 522) and a capacitance (C2).

A timing chart of the photo sensor circuit shown in FIG. 15 is shown in FIG. 16.

An input signal PIN charges the capacitance (C2) to the voltage of VH through the NMOS transistor 522 connected in a diode connection.

The clock signal PCK is inputted at timings of times (t31, t32). At these timings, when a voltage V(#4) of a node #4 is higher than the threshold voltage (Vth) of the NMOS transistor 521, a pulse signal (output signal POUT) with the same timing of the clock signal PCK is outputted, while when the voltage V(#4) of a node #4 is lower than the threshold voltage (Vth) of the NMOS transistor 521, the pulse signal is not outputted.

Here, in a state that the external light illuminance is high and it is bright, the photocurrent (ip1) is large and hence, the voltage of V(#4) of the node #4 is decreased, and a pulse signal having the same phase as the clock signal PCK is not outputted as an output signal POUT.

On the other hand, in a state that the external light illuminance is low and it is dark, the photocurrent (ip1) is small and hence, the voltage of V(#4) of the node #4 is stably kept whereby a pulse signal having the same phase as the clock signal PCK is outputted as the output signal POUT.

The condition in which the pulse signal having the same phase as the clock signal PCK is not outputted as the output signal POUT is expressed by the following formula (11).
ip1>C2×(VH−2×Vth)/T31 (11)

Here, VH is a voltage of the input signal PIN, Vth is threshold voltages of NMOS transistors (521, 522), and T31 is a period between time t21 and time t31.

According to the above-mentioned formula (11), it is understood that the size of the photocurrent (ip1) can be detected using the period T31. Accordingly, in the example shown in FIG. 15, it is possible to detect the photocurrent (ip1) using the NMOS single channel circuit.

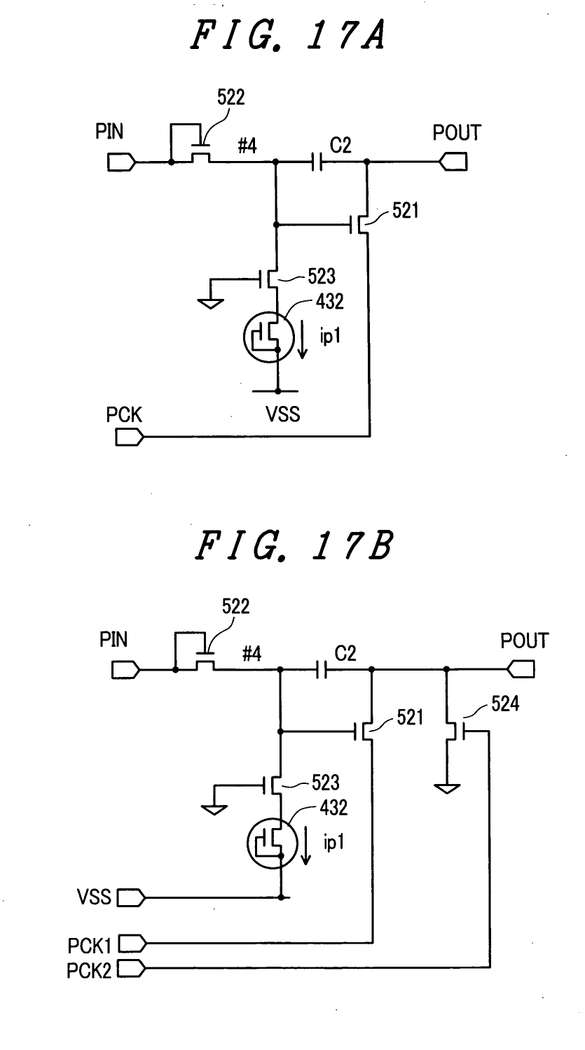

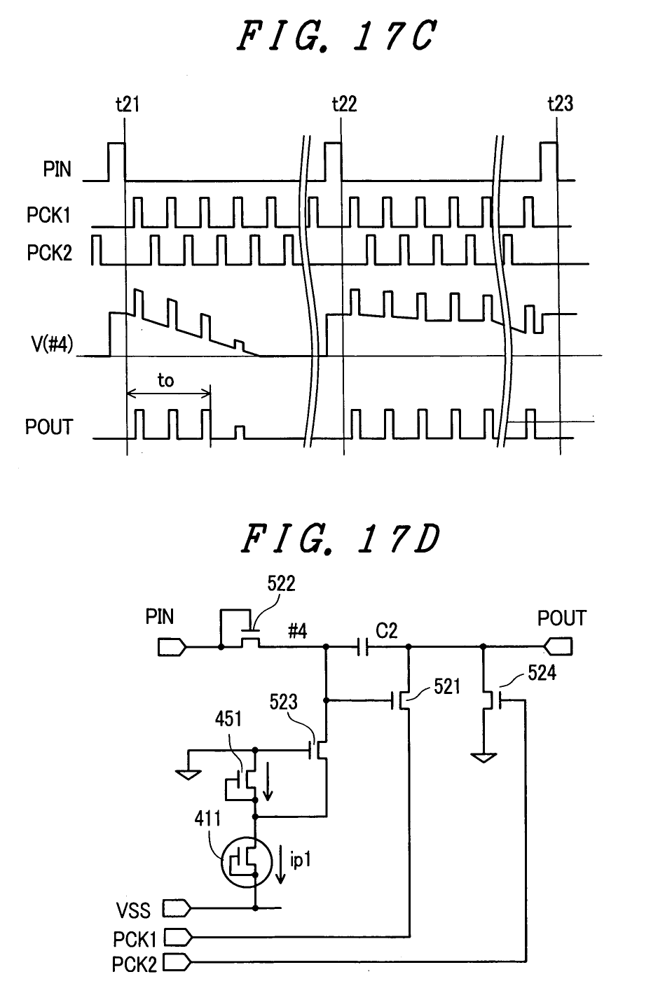

FIG. 17A is a circuit diagram showing the circuit constitution of another embodiment of the photo sensor circuit 500 shown in FIG. 1. The photo sensor circuit 500 shown in FIG. 17A and the photo sensor circuit 500 shown in FIG. 15 differ from each other with respect to the connection of the NMOS transistor 523 and the photo sensor 432.

In the photo sensor circuit 500 shown in FIG. 17A, the charge of the capacitance (C2) is discharged as the photocurrent (ip1) of the photo sensor 432 via the NMOS transistor 523 having a gate thereof grounded. As a result, the parasitic capacitance of the photo sensor 432 is not connected to the node #4 and hence, the lowering of the photocurrent detection sensitivity attributed to the parasitic capacitance of the photo sensor 432 is prevented.

FIG. 17B is a circuit diagram showing circuit constitution of another embodiment of the photo sensor circuit 500 shown in FIG. 1. The constitution which makes the photo sensor circuit 500 of this embodiment different from the photo sensor circuit 500 shown in FIG. 17A lies in that an NMOS transistor 524 is connected to the photo sensor circuit 500, the NMOS transistor 524 is operated in response to a clock (PCK2), and an output (POUT) is connected to a ground potential.

A timing chart of the photo sensor circuit 500 shown in FIG. 17B is shown in FIG. 17C. The constitution which makes this timing different from the timing shown in FIG. 16 lies in that two-phase clocks (PCK1, PCK2) are inputted, and a holding time (to) in which an output (POUT) assumes a predetermined value (VT1) or more assumes as a detection signal. As a result, the parasitic capacitance of the photo sensor 432 is not connected to the node #4 and hence, the lowering of the photocurrent detection sensitivity attributed to the parasitic capacitance of the photo sensor 432 is prevented. Further, the output (POUT) is periodically connected to the ground potential in response to a clock (PCK2) and hence, it is possible to output the ground potential in a stable manner even when the holding time (to) is short.

FIG. 17D is a circuit diagram showing the circuit constitution of another embodiment of the photo sensor circuit 500 shown in FIG. 1. The constitution which makes the photo sensor circuit 500 of this embodiment different from the photo sensor circuit 500 shown in FIG. 17B lies in that a thin film transistor 451 for correcting dark current is added to the photo sensor circuit 500.

In the photo sensor circuit 500 shown in FIG. 17B, in the same manner as the photo sensor circuit 500 shown in FIG. 6A, a dark current of the photo sensor 411 is corrected and hence, it is possible to realize the detection of the illuminance with higher accurately.

Here, in the photo sensor circuits 500 shown in FIG. 15, FIG. 17A, FIG. 17B and FIG. 17D, the photo sensor circuit 500 may be also formed of a PMOS single channel circuit in place of the NMOS single channel circuit.

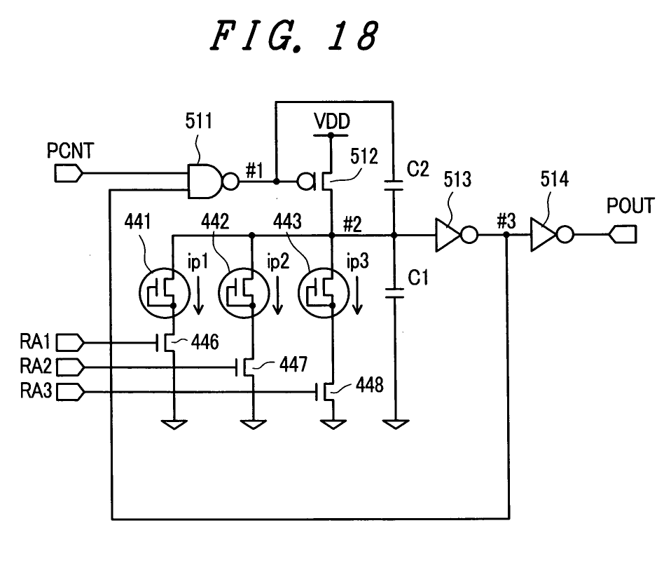

FIG. 18 is a circuit diagram showing the circuit constitution of another embodiment of the photo sensor circuit 500 shown in FIG. 1.

The photo sensor circuit shown in FIG. 18 differs from the photo sensor circuit shown in FIG. 6A with respect to a point that the photo sensor circuit 500 includes photo sensors (441, 442, 443) which differ in size, and NMOS transistors (446, 447, 448) which are connected to these photo sensors in series.

Range changeover signals (RA1, RA2, RA3) are inputted to respective gate terminals of the NMOS transistors (446, 447, 448).

In the example shown in FIG. 18, it is possible to change over the illuminance detection sensitivity by selecting a single or a plurality of photo sensors (441, 442, 443) out of the NMOS transistors (446, 447, 448) in response to a range changeover signal.

### Embodiment 2

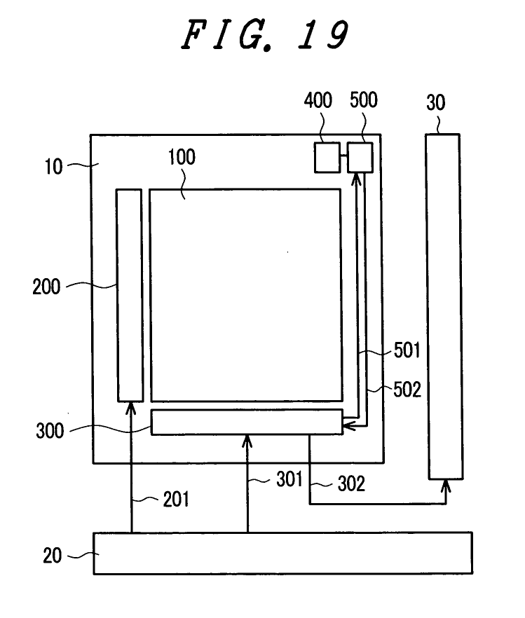

FIG. 19 is a block diagram showing the schematic constitution of a liquid crystal display device of an embodiment 2 of the present invention.

In this embodiment, an input signal 501 of the photo sensor circuit 500 and a backlight control signal 302 are outputted from a drain circuit 300, while an output signal 502 of the photo sensor circuit 500 is inputted to the drain circuit 300.

In the above-mentioned embodiment, the control circuit 20 is formed on a set substrate of a liquid crystal panel applicable product, and the drain circuit 300 formed in the inside of the semiconductor chip which is COG (Chip on Glass)-mounted on a TFT substrate, and a gate circuit 200, a photo sensor 400 and a photo sensor circuit 500 are formed on the same substrate as a substrate on which thin film transistors of respective pixels in the display part 100 are formed.

Accordingly, as signal lines between the control circuit 20 and the liquid crystal display panel 10, signal lines for an input signal 501 and an output signal 502 of the photo sensor circuit 500 and the backlight control signal 302 become necessary. According to this embodiment, it is possible to reduce the number of signal lines between the control circuit 20 and the liquid crystal display panel 10. Further, it is possible to reduce a circuit size of the control circuit 20.

### Embodiment 3

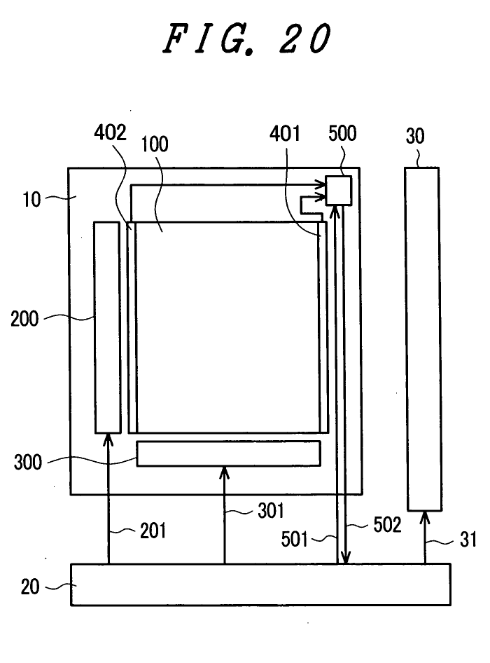

FIG. 20 is a block diagram showing the schematic constitution of the liquid crystal display device of the embodiment 3 of the present invention.

In this embodiment, photo sensors (401, 402) are arranged at left and right sides of the display part 100.

The photo sensors require a transistor having a gate width of several ten thousand μm for enhancing the illuminance detection sensitivity. By providing the photo sensors on left and right sides of the display part, such photo sensors are realized and, at the same time, by providing the photo sensors around the display part, it is unnecessary to particularly provide a mechanism for fetching an external light.

As has been explained heretofore, according to the above-mentioned respective embodiments, at the time of detecting the external light illuminance around the liquid crystal display panel 10, the backlight 30 is turned off and hence, it is possible to completely eliminate the influence of the backlight light thus enabling the accurate detection of the external light illuminance.

Further, the photo sensor circuit 500 outputs extremely weak signals by converting the signals into a pulse width or frequency and hence, there is no possibility that the photo sensor circuit 500 is influenced by noises of the signal output line.

Still further, the control circuit 20 uses the pulse width or frequency as the input and hence, the control circuit 20 may be constituted of a digital circuit.

Still further, the detection period of the external light illuminance around the liquid crystal display panel 10 is shortened when the external light illuminance is high and is prolonged when the external light illuminance is low and hence, it is possible to enhance the detection accuracy.

Further, the frequency (fout) of the output signal (POUT) is inversely proportional to a product of the capacitance (C2) and the reference voltage (VREF) and does depend on the parasitic capacitance of the photo sensor and hence, it is possible to reduce the irregularities of the frequency (fout) of the output signal (POUT).

Further, by correcting the dark current, it is possible to detect the further lower illuminance.

Still further, by adding the transistor in cascade connection to the photo sensor, the fluctuation of the voltage applied to the photo sensor can be reduced thus enabling the acquisition of the output which exhibits the excellent linearity.

In this manner, according to this embodiment, by controlling the backlight illuminance by the external illuminance detecting circuit, it is possible to realize the display with excellent visibility.

Here, in the above-mentioned respective embodiments, the control signal 201 which is inputted to the gate circuit 200 may be outputted from a control circuit not shown in the drawing which in incorporated into the drain circuit 300.

Further, the control circuit 20 may be mounted on a flexible printed circuit board which is connected to a liquid crystal display panel.

Sill further, the control circuit 20 may be incorporated into the drain circuit 300 which is COG mounted or the drain circuit 300 may not be constituted of a semiconductor chip but may be integrally formed on a TFT substrate 610 by using low-temperature silicon or the like.

Further, in this embodiment, the external light is fetched from the surrounding of the display part and hence, it is unnecessary to perform the frame forming for fetching the external light.

Further, by performing the backlight control using the drain circuit 300 which is COG mounted, it is possible to reduce a load applied to the control circuit 20 and, at the same time, it is possible to reduce the number of control signals which are transmitted from the control circuit 20 to the liquid crystal display panel 10 and the backlight 30.

Further, the present invention is applicable not only to the control of the brightness of the backlight but also to the control of the brightness of the display panel.

Still further, the illuminance detecting circuit of the present invention is not limited to the liquid crystal display device and is also applicable to a display device of other type. Here, with respect to a self-luminous-type display device, in place of controlling the backlight, the light emitting brightness per se of the display panel can be controlled.

Although the present invention has been specifically explained in conjunction with the embodiments, it is needless to say that the present invention is not limited to the above-mentioned embodiments and various modifications are conceivable without departing from the gist of the present invention.

What is claimed is:

1. A liquid crystal display device comprising:
a liquid crystal display panel;
a backlight;
a photo sensor;
a photo sensor circuit which measures an external light illuminance around the liquid crystal display panel using the photo sensor; and
a control circuit which controls the backlight and the photo sensor circuit, wherein
the control circuit periodically turns off the backlight and, at the same time, periodically outputs a control signal to start the measurement of the external light illuminance around the liquid crystal display panel to the photo sensor circuit, and controls the brightness of the backlight in response to the external light illuminance which is measured by the photo sensor circuit and is inputted from the photo sensor circuit, and
the photo sensor circuit measures the external light illuminance around the liquid crystal display panel within an illuminance measuring period within a turn-off period of the backlight based on the control signal and outputs the measured external light illuminance to the control circuit, and
the control circuit changes the illuminance measuring period in response to the external light illuminance measured by the photo sensor circuit.

2. A liquid crystal display device according to claim 1, wherein the control circuit changes the illuminance measuring period and the turn-off period of the backlight in response to the external light illuminance measured by the photo sensor circuit.

3. A liquid crystal display device according to claim 1, wherein the control circuit shortens the illuminance measuring period when the external light illuminance measured by the photo sensor circuit is large and prolongs the illuminance measuring period when the external light illuminance measured by the photo sensor circuit is small.

4. A liquid crystal display device according to claim 1, wherein the control circuit shortens the turn-off period of the backlight when the external light illuminance measured by the photo sensor circuit is large and prolongs the turn-off period of the backlight when the external light illuminance measured by the photo sensor circuit is small.

5. A liquid crystal display device according to claim 1, wherein the control circuit prolongs a turn-on period of the backlight when the external light illuminance measured by the photo sensor circuit is large and shortens the turn-on period of the backlight when the external light illuminance measured by the photo sensor circuit is small.

6. A liquid crystal display device according to claim 1, wherein the photo sensor circuit outputs a pulse signal which differs in a pulse width of a first voltage level in response to the measured external light illuminance.

7. A liquid crystal display device according to claim 6, wherein the photo sensor circuit outputs a pulse signal having a short pulse width of the first voltage level when the measured external light illuminance is large and outputs a pulse signal having a long pulse width of the first voltage level when the measured external light illuminance is small.

8. A liquid crystal display device according to claim 6, wherein the control circuit shortens the illuminance measuring period when the pulse width of the first voltage level inputted from the photo sensor circuit is short and prolongs the illuminance measuring period when the pulse width of the first voltage level inputted from the photo sensor circuit is long.

9. A liquid crystal display device according to claim 6, wherein the control circuit shortens the turn-off period of the backlight when the pulse width of the first voltage level inputted from the photo sensor circuit is short and prolongs the turn-off period of the backlight when the pulse width of the first voltage level inputted from the photo sensor circuit is long.

10. A liquid crystal display device according to claim 6, wherein the control circuit prolongs the turn-on period of the backlight when the pulse width of the first voltage level inputted from the photo sensor circuit is short and shortens the turn-on period of the backlight when the pulse width of the first voltage level inputted from the photo sensor circuit is long.

11. A liquid crystal display device according to claim 6, wherein assuming Tp1, Tp2 (Tp1>Tp2) as first and second pulse widths of the first voltage level respectively and TB1, TB2, TB3 (TB1<TB2<TB3) as first to third turn-on periods of the backlight respectively, the control circuit sets the turn-on period TB of the backlight to TB1 (TB=TB1) when the pulse width Tp of the first voltage level inputted from the photo sensor circuit is Tp>Tp1,
sets the turn-on period TB of the backlight to TB2 (TB=TB2) when the pulse width Tp of the first voltage level inputted from the photo sensor circuit is Tp1≧Tp>Tp2, and
sets the turn-on period TB of the backlight to TB3 (TB=TB3) when the pulse width Tp of the first voltage level inputted from the photo sensor circuit is Tp2≧Tp.

12. A liquid crystal display device according to claim 6, wherein assuming Tp1, Tp2 (Tp1>Tp2) as first and second pulse widths of the first voltage level respectively and TB1, TB2, TB3 (TB1<TB2<TB3) as first to third turn-on periods of the backlight respectively, the control circuit sets the turn-on period TB of the backlight to TB1 (TB=TB1) when the turn-on period of the backlight at a point of time that the external light illuminance is measured is TB1, and the pulse width Tp of the first voltage level inputted from the photo sensor circuit is Tp>Tp1,
sets the turn-on period TB of the backlight to TB2 (TB=TB2) when the turn-on period of the backlight at a point of time that the external light illuminance is measured is TB1, and the pulse width Tp of the first voltage level inputted from the photo sensor circuit is Tp≦Tp1,
sets the turn-on period TB of the backlight to TB1 (TB=TB1) when the turn-on period of the backlight at a point of time that the external light illuminance is measured is TB2, and the pulse width Tp of the first voltage level inputted from the photo sensor circuit is Tp>Tp1,
sets the turn-on period TB of the backlight to TB2 (TB=TB2) when the turn-on period of the backlight at a point of time that the external light illuminance is measured is TB2, and the pulse width Tp of the first voltage level inputted from the photo sensor circuit is Tp1≧Tp>Tp2,
sets the turn-on period TB of the backlight to TB3 (TB=TB3) when the turn-on period of the backlight at a point of time that the external light illuminance is measured is TB2, and the pulse width Tp of the first voltage level inputted from the photo sensor circuit is Tp2>Tp,
sets the turn-on period TB of the backlight to TB3 (TB=TB3) when the turn-on period of the backlight at a point of time that the external light illuminance is measured is TB3, and the pulse width Tp of the first voltage level inputted from the photo sensor circuit is Tp2>Tp, and
sets the turn-on period TB of the backlight to TB2 (TB=TB2) when the turn-on period of the backlight at a point of time that the external light illuminance is measured is TB3, and the pulse width Tp of the first voltage level inputted from the photo sensor circuit is Tp≧Tp2.

13. A liquid crystal display device according to claim 6, wherein the control circuit controls the brightness of the backlight in response to the pulse width of the pulse signal of the first voltage level inputted from the photo sensor circuit.

14. A liquid crystal display device according to claim 1, wherein the liquid crystal display device includes a dark current correcting transistor which corrects a dark current of the photo sensor.

15. A liquid crystal display device according to claim 1, wherein the liquid crystal display device includes a plurality of photo sensors, and
changes over the illuminance detection sensitivity by selecting a predetermined number of photo sensors out of the plurality of photo sensors when the external light illuminance is measured.

16. A liquid crystal display device according to claim 1, wherein the liquid crystal display panel includes a plurality of pixels each of which includes a thin film transistor, and
the photo sensor and the photo sensor circuit are formed on the same substrate on which the thin film transistors of the respective pixels are formed.

17. A liquid crystal display device according to claim 1, wherein the photo sensor is arranged at a dummy pixel portion which is a periphery of a display part of the liquid crystal display panel.

18. A liquid crystal display device according to claim 1, wherein the control circuit is a circuit which is formed in a semiconductor chip.

19. A display device having an illuminance detecting circuit, wherein
the illuminance detecting circuit comprising:
a photo sensor which changes a photocurrent in response to an external light illuminance;
a capacitance from which a charge is discharged in response to flowing of the photocurrent to the photo sensor;
an inverting circuit which is operated in response to inputting of a voltage of the capacitance; and
a switch of which an output is connected to one end of the capacitance and charges the capacitance corresponding to an output signal level of the inverting circuit, wherein
a voltage level of another end of the capacitance is changed corresponding to an output signal level of the inverting circuit.

20. A display device according to claim 19, wherein when the output signal level of the inverting circuit is high, the switch is turned on and, at the same time, the voltage level of another end of the capacitance is set to a first voltage,
while when the output signal level of the inverting circuit is low, the switch is turned off and, at the same time, the voltage level of another end of the capacitance is set to a second voltage.

21. A display device according to claim 20, wherein the first voltage is lower than the second voltage.

22. A display device according to claim 20, wherein the second voltage is a reference voltage.

23. A display device according to claim 19, wherein the second capacitance is connected to an input of the inverting circuit.

24. A display device according to claim 19, wherein the display device includes a dark current correction transistor which corrects a dark current of the photo sensor.

25. A display device according to claim 19, wherein the display device includes a third transistor which is connected to the photo sensor in a cascade connection, and
a charge of the capacitance is discharged by the photo sensor via the third transistor.

26. A display device according to claim 19, wherein the illuminance detecting circuit is integrally formed on a substrate on which pixels or a peripheral circuit which constitute the display device are formed.

27. A display device which includes the illuminance detecting circuit, wherein
the illuminance detecting circuit comprising:
a photo sensor which changes a photocurrent in response to an external light illuminance;
a capacitance from which a charge is discharged in response to flowing of the photocurrent to the photo sensor; and
a first transistor which outputs a clock inputted to a first terminal when a voltage of the capacitance becomes a predetermined voltage or more.

28. A display device according to claim 27, wherein the first terminal is a source-electrode-side terminal of the first transistor,
the output is outputted from a drain electrode of the first transistor, and
the capacitance is connected between a gate electrode and the drain electrode of the first transistor.

29. A display device according to claim 27, wherein the display device includes a second transistor which has the output connected to a ground potential in response to a second clock which differs from the clock.

30. A display device according to claim 27, wherein the display device includes a dark current correction transistor which corrects a dark current of the photo sensor.

31. A display device according to claim 27, wherein the display device includes a third transistor which is connected to the photo sensor in a cascade connection, and
a charge of the capacitance is discharged by the photo sensor via the third transistor.

32. A display device according to claim 27, wherein the illuminance detecting circuit is integrally formed on a substrate on which pixels or a peripheral circuit which constitute the display device are formed.
